(19) United States
(12) Patent Application Publication
(10) Pub. No.: US 2025/0102967 A1
(43) Pub. Date: Mar. 27, 2025

(54) FIXING DEVICE AND IMAGE FORMING APPARATUS

(71) Applicant: FUJIFILM Business Innovation Corp., Tokyo (JP)

(72) Inventor: Shogo KAMIYA, Kanagawa (JP)

(73) Assignee: FUJIFILM Business Innovation Corp., Tokyo (JP)

(21) Appl. No.: 18/438,069

(22) Filed: Feb. 9, 2024

(30) Foreign Application Priority Data
Sep. 26, 2023 (JP) 2023-162920

(51) Int. Cl. G03G 15/20

(52) U.S. Cl. CPC G03G 15/2017; G03G 15/2064; G03G 2215/2032

(57) ABSTRACT

A fixing device includes a fixing member to be used in fixing an image on a recording medium; a rotatable member pressed against the fixing member while being allowed to rotate, the rotatable member cooperating with the fixing member in such a manner as to form a pressurization part where the recording medium is to be pressurized; a rotating component configured to rotate the rotatable member by inputting a driving force to a position apart from an axis of the rotatable member; and an urging component configured to urge at least one end of the rotatable member in such a manner as to move the one end in an approaching direction or a retracting direction relative to the fixing member.

### CROSS-REFERENCE TO RELATED APPLICATIONS

This application is based on and claims priority under 35 USC 119 from Japanese Patent Application No. 2023-162920 filed Sep. 26, 2023.

### BACKGROUND

### (i) Technical Field

The present disclosure relates to a fixing device and an image forming apparatus.

### (ii) Related Art

A fixing device disclosed in Japanese Unexamined Patent Application Publication No. 2014-44257, for example, includes a fixing rotatable body having an endless shape and configured to fix toner to a recording medium by heating the toner while rotating, a pressurization rotatable body configured to nip and pressurize the toner and the recording medium in cooperation with the fixing rotatable body, and a support provided at a contact part between the fixing rotatable body and the pressurization rotatable body and supporting the fixing rotatable body from the inner side of the fixing rotatable body such that the peak pressure at the exit, for the recording medium, of the contact part is lower than or equal to the peak pressure at the entrance of the contact part.

### SUMMARY

Here, let us discuss a case where a rotatable member is pressed against a fixing member to be used in fixing an image on a recording medium and cooperates with the fixing member in such a manner as to form a pressurization part where the recording medium is to be pressurized, and the rotatable member is to be rotated with a driving force inputted to a position apart from the axis of the rotating member. If the distance from the rotatable member to the fixing member is different between the two ends of the rotatable member, the difference may influence the fixing of the image on the recording medium.

Aspects of non-limiting embodiments of the present disclosure relate to a configuration in which the influence that may be brought upon the fixing of an image on a recording medium is less than in a configuration in which a rotational driving force transmitted to a rotatable member makes the distance from the rotatable member to a fixing member different between the two ends of the rotatable member.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a fixing device including a fixing member to be used in fixing an image on a recording medium; a rotatable member pressed against the fixing member while being allowed to rotate, the rotatable member cooperating with the fixing member in such a manner as to form a pressurization part where the recording medium is to be pressurized; a rotating component configured to rotate the rotatable member by inputting a driving force to a position apart from an axis of the rotatable member; and an urging component configured to urge at least one end of the rotatable member in such a manner as to move the one end in an approaching direction or a retracting direction relative to the fixing member.

### BRIEF DESCRIPTION OF THE DRAWINGS

Exemplary embodiments of the present disclosure will be described in detail based on the following figures, wherein:

FIG. 1 illustrates an image forming apparatus according to a general embodiment;

FIG. 2 illustrates a configuration of a fixing instrument according to the general embodiment;

FIG. 3 illustrates a moving mechanism and a drive transmission unit included in the fixing instrument;

FIG. 4 illustrates a fixing instrument according to a first exemplary embodiment;

FIG. 5A is a graph illustrating nipping loads at a first end and a second end of a pressure roll, with the vertical axis representing the nipping load, in a state before a rotational driving force is inputted through the drive transmission unit to the pressure roll;

FIG. 5B is a graph illustrating the nipping loads at the first end and the second end of the pressure roll in a state when the rotational driving force is inputted;

FIG. 5C is a graph illustrating the nipping loads at the first end and the second end of the pressure roll in a state after an adjustment with a spring member is done.

FIG. 6 is a graph illustrating the relationship between the driving force of a motor and the nipping load, with the vertical axis representing the change in the nipping load at the first end of the pressure roll and the horizontal axis representing the driving torque;

FIG. 7 illustrates a fixing instrument according to a second exemplary embodiment;

FIG. 8 illustrates cam members included in a fixing instrument according to a third exemplary embodiment; and

FIG. 9 illustrates cam members included in a fixing instrument according to a fourth exemplary embodiment.

### DETAILED DESCRIPTION

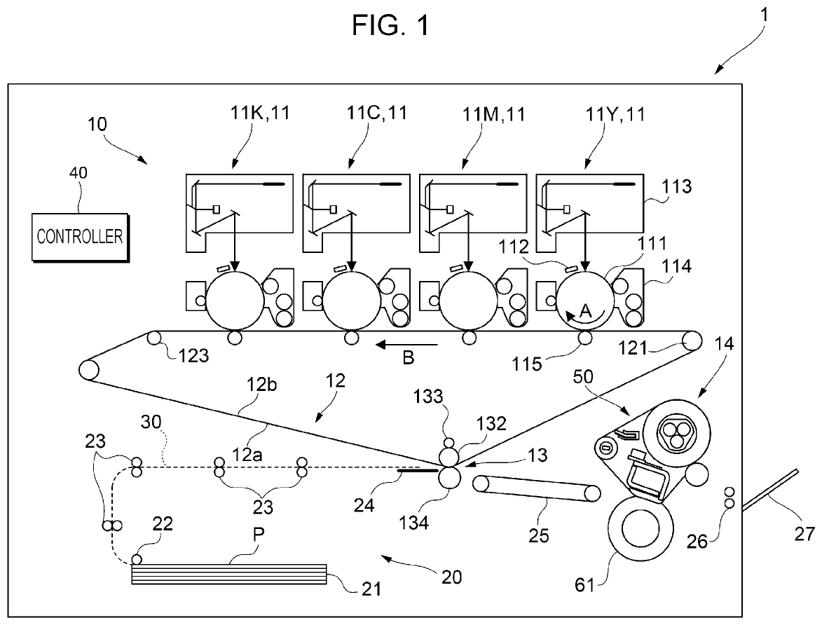

FIG. 1 illustrates an image forming apparatus 1 according to a general embodiment.

The image forming apparatus 1 illustrated in FIG. 1 is an apparatus configured to form an image on a sheet P. The image forming apparatus 1 includes an image forming section 10, a sheet transporting section 20, and a controller 40.

The image forming section 10 includes image forming units 11, an intermediate transfer belt 12, a second-transfer unit 13, and a fixing instrument 14.

In the general embodiment, the image forming units 11 are four image forming units 11Y, 11M, 11C, and 11K, which are provided for respective toners having four respective colors of yellow (Y), magenta (M), cyan (C), and black (K).

The image forming units 11Y, 11M, 11C, and 11K are arranged side by side in a direction in which the intermediate transfer belt 12 rotates, and are configured to electrophotographically form respective toner images.

The image forming units 11Y, 11M, 11C, and 11K each include a photoconductor drum 111, a charging unit 112, an exposure unit 113, a developing unit 114, and a first-transfer unit 115.

The image forming units 11Y, 11M, 11C, and 11K are configured to form respective toner images in the respective colors of Y, M, C, and K and to transfer the toner images to the intermediate transfer belt 12. Thus, the toner images in the respective colors of Y, M, C, and K are superposed one on top of another on the intermediate transfer belt 12 into a toner image.

Specifically, the photoconductor drums 111 are rotated in the direction of arrow A at a predetermined speed. On the peripheral surfaces of the photoconductor drums 111 are to be formed respective electrostatic latent images.

The charging units 112 charge the peripheral surfaces of the respective photoconductor drums 111 to a predetermined potential.

The exposure units 113 radiate respective light beams to the charged peripheral surfaces of the respective photoconductor drums 111, thereby forming respective electrostatic latent images on the peripheral surfaces of the photoconductor drums 111.

The developing units 114 cause the respective toners to adhere to the respective electrostatic latent images formed on the peripheral surfaces of the photoconductor drums 111, thereby forming respective toner images.

The first-transfer units 115 transfer the respective toner images formed on the peripheral surfaces of the photoconductor drums 111 to the intermediate transfer belt 12.

The first-transfer units 115 receive a voltage of a polarity opposite to the polarity for charging the toners. With the voltage, the toner images formed on the peripheral surfaces of the photoconductor drums 111 are electrostatically attracted to the intermediate transfer belt 12 sequentially in such a manner as to be superposed one on top of another on the intermediate transfer belt 12 into one color toner image.

The intermediate transfer belt 12 is supported by a plurality of roll-type members. The intermediate transfer belt 12 has an endless shape and is to be rotated circularly in the direction of arrow B. The intermediate transfer belt 12 has an outer peripheral surface 12a and an inner peripheral surface 12b.

The intermediate transfer belt 12 is intended to transport the toner image. In the general embodiment, the toner image is to be formed on the outer peripheral surface 12a of the intermediate transfer belt 12 and to be transported to the second-transfer unit 13 with the rotation of the intermediate transfer belt 12.

In the general embodiment, a driving roll 121 is employed as one of the roll-type members provided on the inner side of the intermediate transfer belt 12 and is configured to be driven by a motor (not illustrated) in such a manner as to move the intermediate transfer belt 12. Furthermore, an idle roll 123 and a backup roll 132 are employed as other ones of the roll-type members and support the intermediate transfer belt 12.

The above roll-type members are rotatable and are pressed against the inner peripheral surface 12b of the intermediate transfer belt 12.

The sheet transporting section 20 includes a sheet container 21, in which a plurality of sheets P are stacked; and a pickup roll 22, which is configured to pick up a sheet P from the sheet container 21 and to transport the sheet P.

The sheet transporting section 20 further includes transporting rolls 23, with which the sheet P picked up by the pickup roll 22 is transported along a sheet transport path 30; and a sheet guide 24, with which the sheet P transported by the transporting rolls 23 is guided to the second-transfer unit 13.

The sheet transporting section 20 further includes a transporting belt 25, with which the sheet P having undergone a second-transfer process is transported to the fixing instrument 14; and a sheet guide 26, with which the sheet P having undergone a fixing process is guided to a sheet output part 27.

The second-transfer unit 13 includes a second-transfer roll 134, which is provided in contact with the outer peripheral surface 12a of the intermediate transfer belt 12; and the backup roll 132, which is provided facing the inner peripheral surface 12b of the intermediate transfer belt 12 and serves as a counter electrode for the second-transfer roll 134.

In the general embodiment, the backup roll 132 is provided with a power feeding roll 133, which is made of metal and is configured to apply a second-transfer bias to the backup roll 132.

In the second-transfer unit 13 configured as above, the toner image transported to the second-transfer unit 13 by the intermediate transfer belt 12 is transferred to the sheet P transported to the second-transfer unit 13.

The fixing instrument 14 is located on the downstream side relative to the second-transfer unit 13 in the direction of transport of the sheet P. The fixing instrument 14 includes a fixing-belt module 50, which includes a heat source; and a pressure roll 61, which is provided facing the fixing-belt module 50.

When the sheet P having passed through the second-transfer unit 13 is transported into the part between the fixing-belt module 50 and the pressure roll 61, the toner image that is yet to be fixed on the sheet P is melted and is fixed on the sheet P. Thus, an image composed of the toner image is obtained on the sheet P.

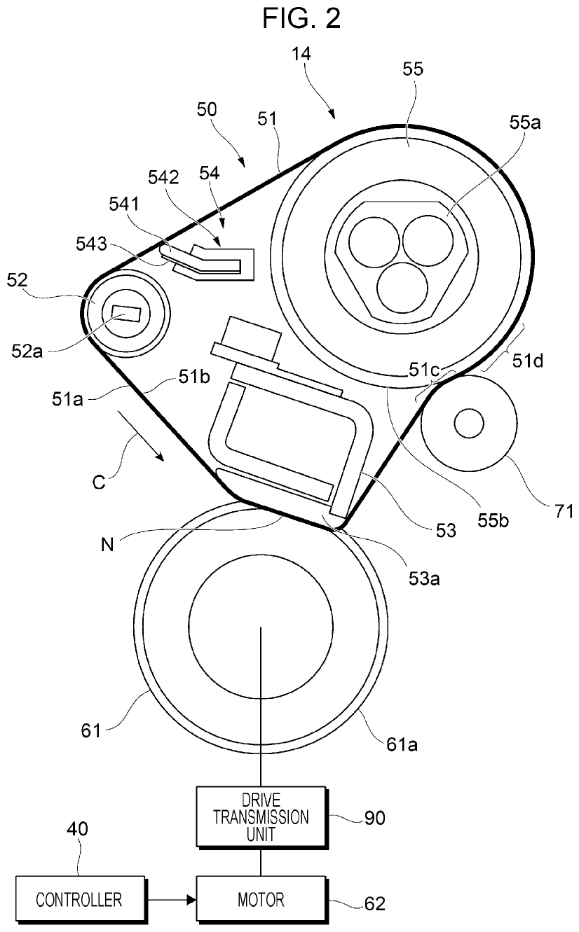

FIG. 2 illustrates a configuration of the fixing instrument 14 according to the general embodiment.

As illustrated in FIG. 2, the fixing instrument 14 according to the general embodiment includes the above-mentioned fixing-belt module 50, which includes a fixing belt 51; and the above-mentioned pressure roll 61, which is provided in contact with the outer peripheral surface, 51a, of the fixing belt 51.

The fixing-belt module 50 includes the above-mentioned fixing belt 51, which is to be made to undergo a circular motion in the direction of arrow C; and a first stretch roll 52, which stretches the fixing belt 51 from the inner side of the fixing belt 51. The fixing-belt module 50 further includes a second stretch roll 55, which stretches the fixing belt 51 from the inner side of the fixing belt 51 at a position on the upstream side relative to the first stretch roll 52 in the direction of arrow C. The fixing-belt module 50 further includes a pressing unit 53, which is located on the downstream side relative to the first stretch roll 52 in the direction of arrow C and includes a pad 53a. The pad 53a is intended to form a nip part N by pressing the fixing belt 51 against the pressure roll 61.

In the fixing instrument 14, a part of the outer peripheral surface, 61a, of the pressure roll 61 located across from the pressing unit 53 is pressed against a part of the outer peripheral surface 51a of the fixing belt 51 that is in contact with the pressing unit 53, whereby the nip part N is formed. The nip part N where the outer peripheral surface 61a of the pressure roll 61 and the fixing belt 51 are in contact with each other is regarded as a passing part through which the sheet P having a toner image formed thereon passes while being pressurized and heated.

The sheet P approaching the nip part N has a toner-image-formed surface on which a toner image has been formed. In the general embodiment, the sheet P approaches the nip part N with the toner-image-formed surface facing upward. Therefore, in the general embodiment, the toner-image-formed surface of the sheet P comes into contact with the fixing belt 51.

In the general embodiment, the pressure roll 61 is driven to rotate by a motor 62, and the fixing belt 51 undergoes a circular motion by following the pressure roll 61. That is, the fixing belt 51 undergoes a circular motion (rotates circularly) in the direction of arrow C by receiving a driving force from the rotating pressure roll 61.

More specifically, a rotational driving force is generated by the motor 62 and is transmitted to the pressure roll 61 through a drive transmission unit 90. The driving of the motor 62 is controlled by the controller 40.

The first stretch roll 52 and the second stretch roll 55 are supported in a rotatable manner with the fixing belt 51 being wrapped therearound at the respective positions that are apart from each other, thereby supporting the fixing belt 51 while allowing the fixing belt 51 to undergo a circular motion. The pressing unit 53 is located across the fixing belt 51 from the pressure roll 61 and presses, without rotating, the fixing belt 51 against the pressure roll 61. The pressure roll 61 includes an elastically deformable layer on the outer peripheral side thereof. The pressing unit 53 is positioned in contact with the pressure roll 61 with the fixing belt 51 in between, whereby the pressure roll 61 is compressed at the nip part N. In the general embodiment, the sheet P is to be nipped from both sides thereof by the pressure roll 61 and the pressing unit 53 so that a pressure is to be applied to the sheet P.

The first stretch roll 52 is provided thereinside with a heater 52a. The second stretch roll 55 is also provided thereinside with a heater 55a. The heaters 52a and 55a are halogen heaters, for example. Heat generated by the heater 52a heats the first stretch roll 52, and heat generated by the heater 55a heats the second stretch roll 55. The heat generated by the first stretch roll 52 and the second stretch roll 55 heats the fixing belt 51.

In the general embodiment illustrated in FIG. 2, the fixing belt 51 is wrapped around the outer peripheral surface of the first stretch roll 52 by a length about a quarter of the circumference of the first stretch roll 52. The fixing belt 51 is also wrapped around the outer peripheral surface, 55b, of the second stretch roll 55 by a length about a half or greater of the circumference of the second stretch roll 55. Thus, heat of an amount generated by the heaters 52a and 55a is applied to the fixing belt 51.

The fixing-belt module 50 includes a liquid applicator 54, which is located between the first stretch roll 52 and the second stretch roll 55 and is configured to apply oil to the inner peripheral surface, 51b, of the fixing belt 51. The liquid applicator 54 includes an oil-impregnated member 541, which is in contact with the inner peripheral surface 51b of the fixing belt 51; a housing 542, which holds the oil-impregnated member 541; and a supporting member 543, which supports a part, including the tip, of the oil-impregnated member 541 from a side across the oil-impregnated member 541 from the fixing belt 51.

The oil-impregnated member 541 is a piece of nonwoven fabric made of heat-resistant fibers and is impregnated with oil. Examples of heat-resistant fibers include polytetrafluoroethylene (PTFE). The oil applied to the inner peripheral surface 51b of the fixing belt 51 by the oil-impregnated member 541 reduces the coefficient of friction between the pressing unit 53 and the fixing belt 51 and thus reduces the wear of the fixing belt 51.

The fixing-belt module 50 includes an upstream cleaning roll 71, which is intended to clean the outer peripheral surface 51a of the fixing belt 51.

The upstream cleaning roll 71 serves as a cleaning member intended to clean the outer peripheral surface 51a of the fixing belt 51 and is, more specifically, configured to remove unwanted matter and the like adhered to the outer peripheral surface 51a of the fixing belt 51 from a part of the fixing belt 51 that has passed through the nip part N.

The upstream cleaning roll 71 is located on the upstream side relative to the second stretch roll 55 at such a position as to nip the fixing belt 51 in cooperation with the second stretch roll 55. In other words, the upstream cleaning roll 71 is located at an approach part of the second stretch roll 55 in such a manner as to bring a part of the fixing belt 51 that is apart from the second stretch roll 55 into contact with the second stretch roll 55.

The upstream cleaning roll 71 according to the general embodiment has a surface formed of nonwoven fabric or felt, or of a porous member. The upstream cleaning roll 71 according to the general embodiment is a follower roll configured to rotate by being in contact with the fixing belt 51 that is undergoing a circular motion.

As illustrated in FIG. 2, the part of the fixing belt 51 that has passed through the nip part N is then nipped between the upstream cleaning roll 71 and the second stretch roll 55, thereby deforming into an S shape. More specifically, the fixing belt 51 deforms in such a manner as to have an inwardly protruding part 51c and an outwardly protruding part 51d, which are continuous with each other. The inwardly protruding part 51c protrudes on the side of the inner peripheral surface 51b of the fixing belt 51 while running along the upstream cleaning roll 71. The outwardly protruding part 51d protrudes on the side of the outer peripheral surface 51a of the fixing belt 51 while running along the second stretch roll 55.

The inwardly protruding part 51c is formed at the approach part, for the fixing belt 51, of the second stretch roll 55 with the deformation of the fixing belt 51 pressed by the upstream cleaning roll 71.

With such an S-shaped deformation, the locus of the fixing belt 51 is defined at the approach part, for the fixing belt 51, of the second stretch roll 55 with the pressing of the fixing belt 51 by the upstream cleaning roll 71.

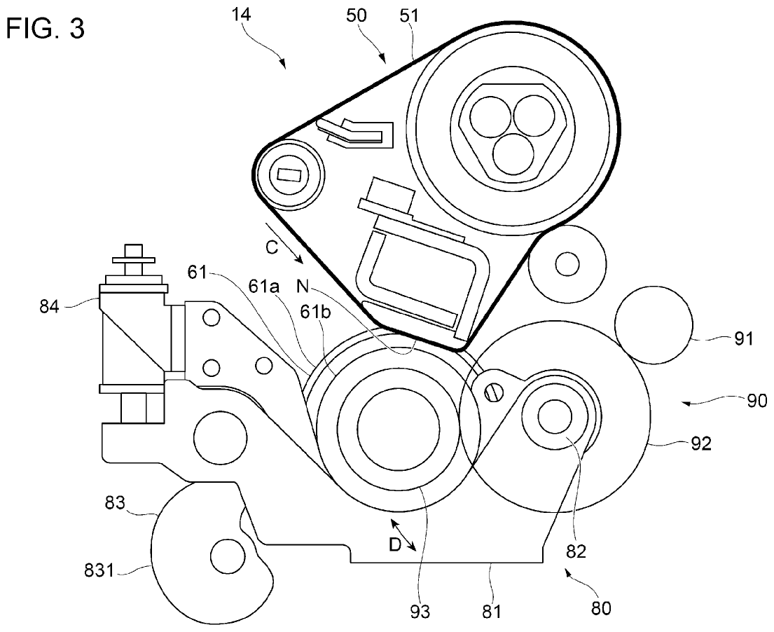

FIG. 3 illustrates a moving mechanism 80 and the drive transmission unit 90, which are included in the fixing instrument 14.

As illustrated in FIG. 3, the fixing instrument 14 includes the moving mechanism 80, which is capable of moving the pressure roll 61 in a toward-and-away direction relative to the fixing-belt module 50. The fixing instrument 14 further includes the above-mentioned drive transmission unit 90 configured to transmit the rotational driving force of the motor 62 to the pressure roll 61. The moving mechanism 80 and the drive transmission unit 90 will now be described.

The fixing-belt module 50 of the fixing instrument 14 is the same as the one illustrated in FIG. 2, and some description thereof is omitted.

### Moving Mechanism 80

As illustrated in FIG. 3, the moving mechanism 80 includes a body 81, a pivot 82, a cam member 83, and a spring member 84.

The body 81 supports the pressure roll 61 at rotation shafts 61b, which are provided at the two respective ends of the pressure roll 61, while allowing the rotation of the pressure roll 61.

The body 81 is movable relative to the body of the fixing instrument 14. More specifically, the body 81 is rotatable about the pivot 82. The pivot 82 is not displaceable relative to the fixing-belt module 50.

Therefore, the pressure roll 61 supported by the body 81 is movable with the movement of the body 81 in the direction of arrow D. That is, the pressure roll 61 is movable toward and away from the fixing-belt module 50 or the pressing unit 53.

The cam member 83 is a disc-type member having a cam surface 831. The distance between the cam surface 831 and the axis of rotation of the cam member 83 varies with the position of the cam surface 831 in the peripheral direction. The cam member 83 is to be driven by a motor (not illustrated) while the position thereof in the peripheral direction is controlled. The motor (not illustrated) may be a stepping motor, whose position is controllable.

The cam member 83 is located below the body 81. A part of the body 81 is in contact with the cam surface 831, whereby the body 81 is movable up and down about the pivot 82 with the rotation of the cam member 83.

Accordingly, the pressure roll 61 supported by the body 81 is displaceable from a position in contact with the fixing-belt module 50 as illustrated in FIG. 3 to a position (not illustrated) away from the fixing-belt module 50, and vice versa. Thus, the pressure roll 61 is movable with the aid of the cam member 83 in the toward-and-away direction relative to the fixing-belt module 50.

The spring member 84 is fitted in such a manner as to connect the body of the fixing instrument 14 and the body 81 of the moving mechanism 80 to each other. The spring member 84 acts in such a direction as to press the pressure roll 61 against the fixing-belt module 50 and thus keeps generating a nipping load, which is the load exerted at the nip part N.

### Drive Transmission Unit 90

As illustrated in FIG. 3, the drive transmission unit 90 includes a driving gear 91, to which the rotational driving force generated by the motor 62 (see FIG. 2) is to be inputted; a follower gear 92, which is in mesh with the driving gear 91; and a gear 93, which is in mesh with the follower gear 92 and is provided at an end of the pressure roll 61. The driving gear 91, the follower gear 92, and the gear 93 are provided on the body 81 of the moving mechanism 80.

Thus, the driving force of the motor 62 is transmitted to the gear 93 provided at the end of the pressure roll 61 and causes the pressure roll 61 to rotate.

More specifically, in the drive transmission unit 90, the follower gear 92 is coaxial with the pivot 82, and the position where the follower gear 92 is in mesh with the gear 93 provided at the end of the pressure roll 61 is apart from the axis of the pressure roll 61, where a moment may act on the moving mechanism 80.

The meshing between the gears 92 and 93 allows the driving force to be inputted to the pressure roll 61 and causes the pressure roll 61 to rotate. Meanwhile, the input of the driving force generates a reaction force, which tends to move the moving mechanism 80 in the direction of arrow D and therefore tends to change the nipping load.

Note that the sheet P is an exemplary recording medium, the pressing unit 53 is an exemplary fixing member, the pressure roll 61 is an exemplary rotatable member, the nip part N is an exemplary pressurization part, the fixing belt 51 is an exemplary annular member, and the fixing instrument 14 is an exemplary fixing device.

The combination of the motor 62 and the drive transmission unit 90 is an exemplary rotating component. The cam member 83 is an exemplary urging component, and the spring member 84 is an exemplary urging component.

In the general embodiment, the pressing unit 53 (see FIG. 2) is fixed for the formation of the nip part N in the fixing instrument 14 (see FIG. 2) and for the stable traveling of the sheet P (see FIG. 1). To keep the nipping load at a predetermined value by using the fixed pressing unit 53, the pressure roll 61 (see FIG. 2) needs to be urged by using, for example, a spring. To efficiently generate the nipping load by using the pressure roll 61 and cause the pressure roll 61 to move in the direction of arrow D (see FIG. 3, for example), which is the toward-and-away direction relative to the fixed pressing unit 53, the above-described moving mechanism 80 needs to be positioned with the pivot 82 (see FIG. 3, for example) being located on the upstream side or the downstream side relative to the pressure roll 61 in the direction of transport of the sheet P. Furthermore, if the fixed pressing unit 53 is employed, the fixing belt 51 needs to be moved by using the pressure roll 61. Furthermore, if the motion of the pressure roll 61 is based on a latch mechanism, the accuracy between gear axes may be maintained by employing a configuration in which the driving force generated by the motor 62 (see FIG. 2) is inputted to a gear configured to rotate about the pivot 82.

However, in a configuration in which the pressure roll 61 is to be rotated with the driving force inputted to a position at one end of the pressure roll 61 and apart from the axis of the pressure roll 61, the reaction force generated in response to the driving force received at the one end of the pressure roll 61 tends to produce a difference between the nipping load at the one end of the pressure roll 61 and the nipping load at the other end of the pressure roll 61. In other words, the distance between the one end of the pressure roll 61 and the pressing unit 53 tends to become different from the distance between the other end of the pressure roll 61 and the pressing unit 53, and an adverse influence tends to be brought upon the fixing of an image on the sheet P.

In view of the above, the general embodiment employs a configuration in which the influence upon the fixing of an image on the sheet P is reduced by reducing the difference in the distance to the pressing unit 53 between one end and the other end of the pressure roll 61.

Now, a first exemplary embodiment, a second exemplary embodiment, a third exemplary embodiment, and a fourth exemplary embodiment will be described.

### First Exemplary Embodiment

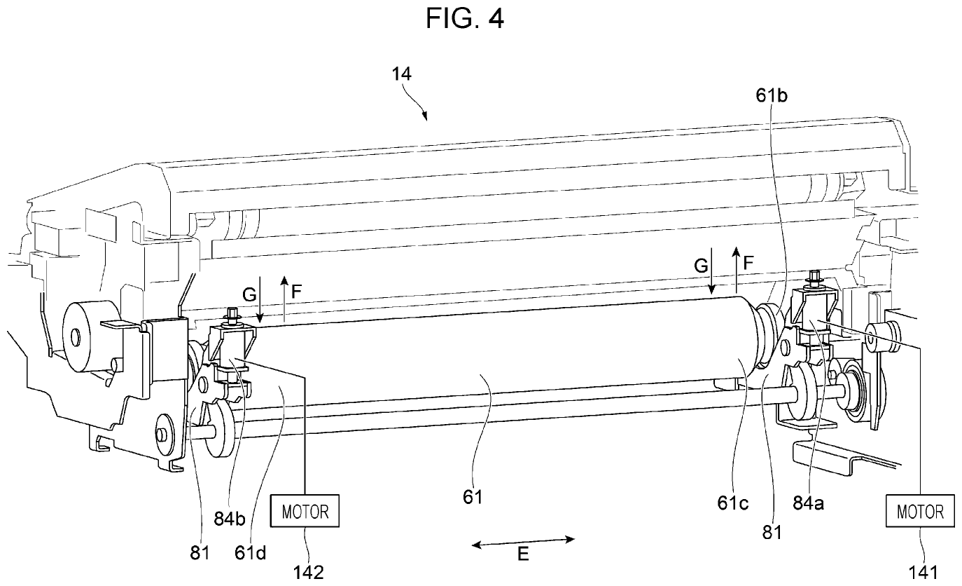

FIG. 4 illustrates a fixing instrument 14 according to a first exemplary embodiment in perspective view so that the length of a pressure roll 61 is perceivable.

As illustrated in FIG. 4, the fixing instrument 14 according to the first exemplary embodiment includes spring members 84a and 84b, which each serve as the spring member 84 described above and are provided at respective positions that are different in a depthwise direction E. Herein, the depthwise direction E refers to a direction perpendicular to the page of FIG. 3.

More specifically, in the axial direction of the pressure roll 61, the spring member 84a is located near a first end, 61c, of the pressure roll 61; and the spring member 84b is located near a second end, 61d, of the pressure roll 61. The drive transmission unit 90 described above is provided near the first end 61c of the pressure roll 61.

The spring member 84a is configured to urge the first end 61c of the pressure roll 61 upward by a degree that is changeable with a driving force that is generated by a motor 141. More specifically, the spring member 84a includes a coil spring and a screw with which the length of the coil spring is changeable. The driving force of the motor 141 causes the screw to move in the lengthwise direction thereof, whereby the length of the spring is changed.

While the driving force of the motor 141 is adjusted, the spring member 84a urges the first end 61c of the pressure roll 61 in an approaching direction For a retracting direction G relative to the pressing unit 53 (see FIG. 2). Thus, the distance from the first end 61c of the pressure roll 61 to the pressing unit 53 (see FIG. 2) is changeable; that is, the nipping load to be generated at the first end 61c is changeable.

The spring member 84b is configured to urge the second end 61d of the pressure roll 61 upward by a degree that is changeable with a driving force that is generated by a motor 142. The spring member 84b has the same configuration as the spring member 84a described above.

While the driving force of the motor 142 is adjusted, the spring member 84b urges the second end 61d of the pressure roll 61 in the approaching direction For the retracting direction G relative to the pressing unit 53 (see FIG. 2). Thus, the distance from the second end 61d of the pressure roll 61 to the pressing unit 53 (see FIG. 2) is changeable; that is, the nipping load to be generated at the second end 61d is changeable.

The change in the distance from each end 61c or 61d of the pressure roll 61 to the pressing unit 53 (see FIG. 2) and the change in the nipping load at each end 61c or 61d have the following relationship: a reduction in the distance increases the nipping load, whereas an increase in the distance reduces the nipping load. Urging the end 61c or 61d of the pressure roll 61 in the approaching direction F relative to the pressing unit 53 increases the nipping load, whereas urging the end 61c or 61d of the pressure roll 61 in the retracting direction G reduces the nipping load.

The motor 141 that drives the spring member 84a and the motor 142 that drives the spring member 84b operate independently of each other. Therefore, it is possible to change the nipping load at one of the first end 61c and the second end 61d of the pressure roll 61.

The motors 141 and 142 may each be a stepping motor.

While the fixing instrument 14 according to the first exemplary embodiment includes the motor 141 provided for the spring member 84a located near the first end 61c of the pressure roll 61 and the motor 142 provided for the spring member 84b located near the second end 61d of the pressure roll 61, the fixing instrument 14 may alternatively employ a configuration including only the motor 142 provided near the second end 61d.

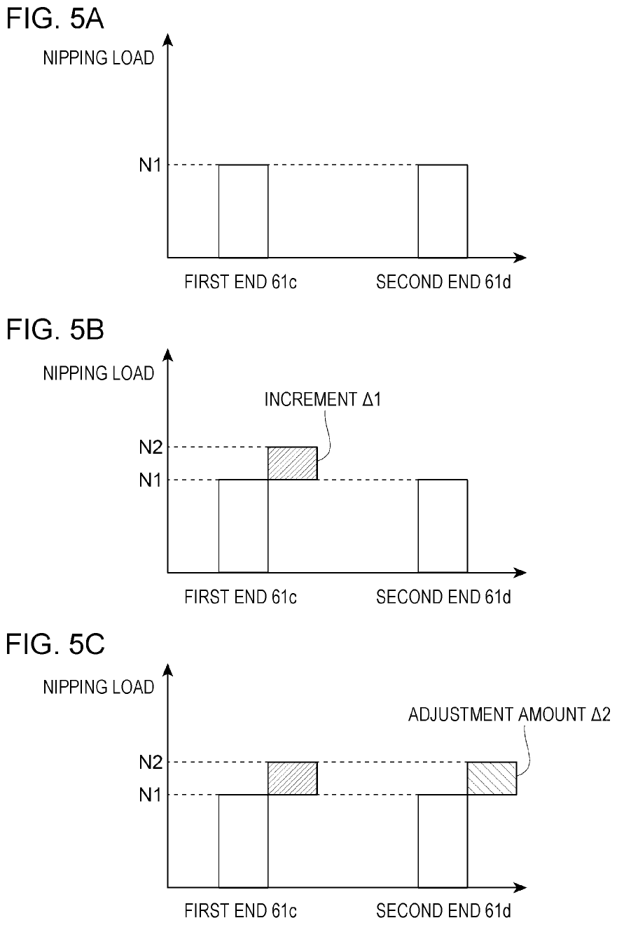

FIGS. 5A to 5C are graphs each illustrating nipping loads at the first end 61c and the second end 61d of the pressure roll 61, with the vertical axis representing the nipping load. FIG. 5A illustrates a state before the rotational driving force is inputted through the drive transmission unit 90 to the pressure roll 61. FIG. 5B illustrates a state when the rotational driving force is inputted. FIG. 5C illustrates a state after an adjustment with the spring member 84b is done.

As illustrated in FIG. 5A, before the rotational driving force is inputted through the drive transmission unit 90 to the pressure roll 61, the nipping loads at the first end 61c and the second end 61d are both N1.

When the rotational driving force is inputted through the drive transmission unit 90 to the pressure roll 61, as illustrated in FIG. 5B, the nipping load at the first end 61c increases by an increment Δ1 and reaches N2. Meanwhile, the nipping load at the second end 61d remains N1. That is, there is a difference in the nipping load between the first end 61c and the second end 61d. Such a difference in the nipping load is attributed to the difference in the distance to the pressing unit 53 (see FIG. 2) between the first end 61c and the second end 61d of the pressure roll 61.

When the motor 142 (see FIG. 4) is operated in such a manner as to increase the nipping load at the second end 61d, as illustrated in FIG. 5C, the nipping load at the second end 61d increases by an adjustment amount Δ2 and reaches N2. Thus, the difference between the nipping load at the first end 61c and the nipping load at the second end 61d is reduced.

While the above description relates to an adjustment where the difference between the nipping load at the first end 61c and the nipping load at the second end 61d is reduced by increasing the nipping load at the second end 61d, the adjustment is not limited to such a method. For example, the nipping load at the first end 61c may be reduced by the increment Δ1. As another alternative, the nipping load may be reduced at the first end 61c and increased at the second end 61d.

Moreover, the difference from a reference torque value of the motor 62 (see FIG. 2) may be detected by using a sensor or the like. Alternatively, such a difference may be calculated through a measurement of the motor current. Specifically, urging by the adjustment amount Δ2 may be performed with reference to the current value of the motor 62. Such urging by the adjustment amount Δ2 may be performed in a preparatory operation to be performed before a sheet P (see FIG. 1) is transported to the fixing instrument 14.

As another alternative, the difference may be calculated from an estimated value obtained through an experiment. Specifically, the urging by the adjustment amount Δ2 may be performed with reference to information representing the relationship between the driving force of the motor 62 and the nipping load.

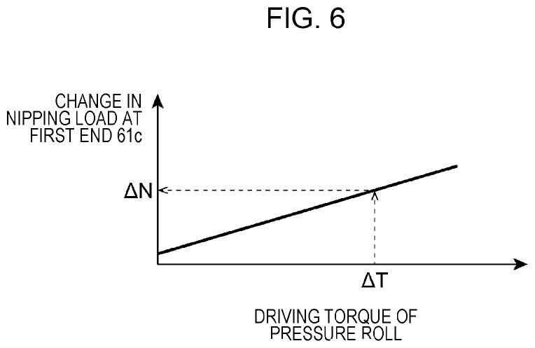

FIG. 6 is a graph illustrating the relationship between the driving force of the motor 62 and the nipping load, with the vertical axis representing the change in the nipping load at the first end 61c of the pressure roll 61 and the horizontal axis representing the driving torque. The driving torque represented by the horizontal axis is the difference between the present value and a target value.

Referring to FIG. 6, the difference, ΔT, between the present value and the target value of the driving torque that is represented by the horizontal axis is calculated and is used to calculate the change, ΔN, in the nipping load at the first end 61c that is represented by the vertical axis. Then, the spring length corresponding to the change AN in the nipping load is calculated, and the motor 142 (see FIG. 4) is operated such that the spring member 84b (see FIG. 4) comes to have the calculated spring length. Thus, urging with the spring member 84b by the adjustment amount Δ2 (see FIG. 5C) is achieved.

### Second Exemplary Embodiment

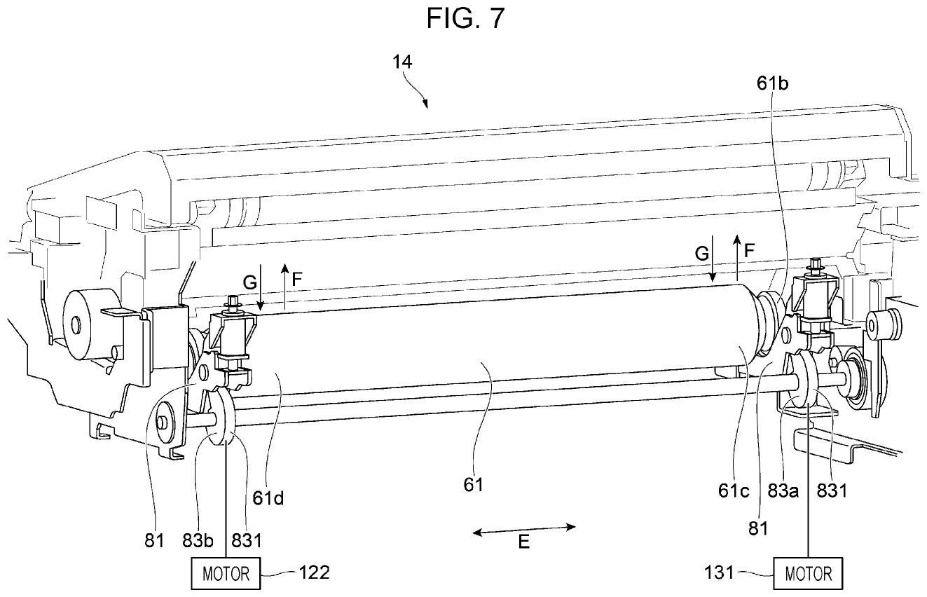

FIG. 7 illustrates a fixing instrument 14 according to a second exemplary embodiment and corresponds to FIG. 4 illustrating the first exemplary embodiment.

As illustrated in FIG. 7, the fixing instrument 14 according to the second exemplary embodiment includes cam members 83a and 83b, which each serve as the cam member 83 described above and are provided at respective positions that are different in the depthwise direction E.

More specifically, in the axial direction of the pressure roll 61, the cam member 83a is located near the first end 61c of the pressure roll 61, and the cam member 83b is located near the second end 61d of the pressure roll 61. In the second exemplary embodiment as well, the drive transmission unit 90 (see FIG. 3) is provided near the first end 61c of the pressure roll 61 as in the first exemplary embodiment.

The cam member 83a and the cam member 83b have the same cam shape.

The cam member 83a is in contact with the body 81 at a cam surface 831 thereof, and the cam member 83b is in contact with the body 81 at a cam surface 831 thereof.

The cam member 83a is rotatable with a driving force generated by a motor 131. The cam member 83a urges the first end 61c of the pressure roll 61 in the approaching direction F or the retracting direction G relative to the pressing unit 53 (see FIG. 2) in correspondence with the contact position at the cam surface 831.

The cam member 83b is rotatable with a driving force generated by a motor 122. The cam member 83b urges the second end 61d of the pressure roll 61 in the approaching direction For the retracting direction G relative to the pressing unit 53 (see FIG. 2) in correspondence with the contact position at the cam surface 831.

The cam member 83a is an exemplary first cam member, and the cam member 83b is an exemplary second cam member.

The motor 131 that rotates the cam member 83a and the motor 122 that rotates the cam member 83b operate independently of each other, and the first end 61c and the second end 61b of the pressure roll 61 are liftable by respectively different amounts. In other words, the relative position of the cam member 83a and the cam member 83b about the axis of rotation thereof is changeable. For example, while the cam member 83a is controlled to rotate, the cam member 83b is controllable not to rotate.

Therefore, it is possible to produce a difference between the distance from the first end 61c of the pressure roll 61 to the pressing unit 53 (see FIG. 2) and the distance from the second end 61d of the pressure roll 61 to the pressing unit 53.

Thus, the distance from one of the first end 61c and the second end 61d of the pressure roll 61 to the pressing unit 53 (see FIG. 2) is changeable, whereby one of the two distances is changeable to be different from the other distance.

The motor 131 and 122 may each be a stepping motor.

The method of adjusting the nipping load is the same between that using the cam members 83a and 83b and that using the spring members 84a and 84b described in the first exemplary embodiment with reference to FIGS. 5A to 5C, and is not described herein.

The adjustment of the nipping load may be performed by using both of the cam members 83a and 83b or by using only one of the cam members 83a and 83b. Specifically, the difference in the nipping load may be reduced by using, for example, the cam member 83b provided at the second end 61d of the pressure roll 61.

In the second exemplary embodiment, the cam members 83a and 83b are rotatable independently of each other, which produces a difference in the amount of lifting between the cam member 83a and the cam member 83b. Such a difference in the amount of lifting is utilized to reduce the difference between the nipping load at the first end 61c of the pressure roll 61 and the nipping load at the second end 61d of the pressure roll 61.

### Third Exemplary Embodiment

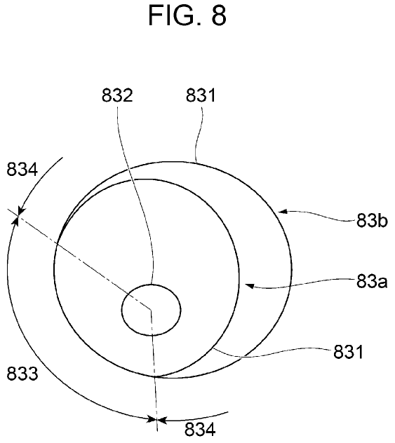

FIG. 8 illustrates cam members 83a and 83b included in a fixing instrument 14 according to a third exemplary embodiment, seen in the direction of the axis of rotation of the cam members 83a and 83b. The configuration of the fixing instrument 14 according to the third exemplary embodiment is the same as in the second exemplary embodiment except the cam members 83a and 83b, and redundant description and illustration thereof is omitted.

In the third exemplary embodiment, the cam members 83a and 83b have respectively different cam shapes.

In the third exemplary embodiment, the cam members 83a and 83b are to be rotated synchronously with each other about a rotation center 832. That is, neither of the cam members 83a and 83b is rotatable alone. More specifically, when the cam member 83a and the cam member 83b rotate, the cam member 83a and the cam member 83b rotate about the rotation center 832 while being kept in a relative position illustrated in FIG. 8. Therefore, the third exemplary embodiment may employ a configuration including only one of the motors 131 and 122 (see FIG. 7) employed in the second exemplary embodiment.

The cam members 83a and 83b each include a conforming part 833, where the outline of the cam surface 831 that is defined about the rotation center 832 conforms to the outline of the other cam member 83a or 83b; and a unique part 834, where the outline of the cam surface 831 is different from the outline of the other cam member 83a or 83b. The conforming part 833 is an exemplary conforming-outline part, and the unique part 834 is an exemplary different-outline part.

While the cam members 83a and 83b according to the third exemplary embodiment each include the conforming part 833 and the unique part 834, the cam members 83a and 83b are not limited to such members and may each include no conforming part 833.

Information on adjustment distances corresponding to predetermined positions of the unique parts 834 of the cam members 83a and 83b is stored. If the nipping load needs to be adjusted because of the reaction force, one of the adjustment distances that is required for that adjustment is used to calculate the amount of rotation of the cam members 83a and 83b.

Comparing the unique part 834 of the cam member 83a and the unique part 834 of the cam member 83b, the distance from the rotation center 832 to the unique part 834 is longer for the cam member 83b than for the cam member 83a. That is, a greater amount of adjustment is possible with the cam member 83b provided at the first end 61c of the pressure roll 61 where the drive transmission unit 90 (see FIG. 3) is provided.

While the cam members 83a and 83b are rotating with the conforming parts 833 thereof being in contact with the body 81 supporting the pressure roll 61, the first end 61c and the second end 61d (see FIG. 7) of the pressure roll 61 are at the same level. The state where the first end 61c and the second end 61d are at the same level is regarded as a state where the nipping load is the same between the first end 61c and the second end 61d.

In the third exemplary embodiment, the cam members 83a and 83b have respectively different shapes, which produces a difference in the amount of lifting between the cam member 83a and the cam member 83b. Such a difference in the amount of lifting is utilized to reduce the difference between the nipping load at the first end 61c (see FIG. 7, for example) of the pressure roll 61 and the nipping load at the second end 61d (see FIG. 7) of the pressure roll 61.

### Fourth Exemplary Embodiment

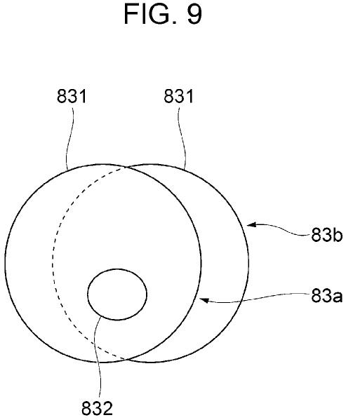

FIG. 9 illustrates cam members 83a and 83b included in a fixing instrument 14 according to a fourth exemplary embodiment, seen in the direction of the axis of rotation of the cam members 83a and 83b. FIG. 9 corresponds to FIG. 8 illustrating the third exemplary embodiment. As with the case of the third exemplary embodiment, the configuration of the fixing instrument 14 according to the fourth exemplary embodiment is the same as in the second exemplary embodiment except the cam members 83a and 83b, and redundant description and illustration thereof is omitted.

The fourth exemplary embodiment employs cam members 83a and 83b that have the same cam shape as in the second exemplary embodiment but unlike in the third exemplary embodiment.

On the other hand, the cam members 83a and 83b according to the fourth exemplary embodiment are rotated synchronously with each other about a rotation center 832 as in the third exemplary embodiment but unlike in the second exemplary embodiment. Therefore, the fourth exemplary embodiment may employ a configuration including only one of the motors 131 and 122 (see FIG. 7) employed in the second exemplary embodiment.

In the fourth exemplary embodiment, the cam members 83a and 83b are out of phase with each other, which produces a difference in the amount of lifting between the cam member 83a and the cam member 83b. Such a difference in the amount of lifting is utilized to reduce the difference between the nipping load at the first end 61c (see FIG. 7, for example) of the pressure roll 61 and the nipping load at the second end 61d (see FIG. 7) of the pressure roll 61.

In the fourth exemplary embodiment, the cam members 83a and 83b have the same cam shape but are out of phase with each other such that the amounts of lifting by the cam members 83a and 83b are increased.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### Appendix

(((1)))

A fixing device comprising:
a fixing member to be used in fixing an image on a recording medium;
a rotatable member pressed against the fixing member while being allowed to rotate, the rotatable member cooperating with the fixing member in such a manner as to form a pressurization part where the recording medium is to be pressurized;
a rotating component configured to rotate the rotatable member by inputting a driving force to a position apart from an axis of the rotatable member; and
an urging component configured to urge at least one end of the rotatable member in such a manner as to move the one end in an approaching direction or a retracting direction relative to the fixing member.
   (((2)))

The fixing device according to (((1))), wherein the urging component includes a cam member.

(((3)))

The fixing device according to (((2))),
wherein the cam member includes a first cam member and a second cam member, the first cam member being provided at the one end, the second cam member being provided at an other end of the rotatable member, the other end being located opposite the one end, and
wherein the urging component is capable of causing at least one of the first cam member and the second cam member to rotate.
   (((4)))

The fixing device according to (((3))),
wherein the first cam member and the second cam member each include a different-outline part where an outline of the cam member that is defined about a rotation center of the cam member is different from an outline of the other cam member.
   (((5)))

The fixing device according to (((4))),
wherein the first cam member and the second cam member each include a conforming-outline part where the outline of the cam member that is defined about the rotation center conforms to the outline of the other cam member.
   (((6)))

The fixing device according to any of (((3))) to (((5))),
wherein the first cam member and the second cam member are out of phase with each other.
   (((7)))

The fixing device according to (((1))),
wherein the urging component includes a spring member provided at the one end of the rotatable member.

(((8)))

The fixing device according to any of (((1))) to (((7))),
wherein the urging component is configured to urge the rotatable member with reference to a current value of a drive source configured to generate the driving force to be inputted by the rotating component.
   (((9)))

The fixing device according to any of (((1))) to (((7))),
wherein the urging component is configured to urge the rotatable member with reference to information representing a relationship between the driving force to be inputted by the rotating component and a degree of the urging.
   (((10)))

The fixing device according to any of (((1))) to (((9))), further comprising:
an annular member that is to be rotated and is provided around the fixing member and the rotatable member,
wherein the annular member is rotated with a driving force generated by the rotatable member.
   (((11)))

An image forming apparatus comprising the fixing device according to (((1))).

What is claimed is:

1. A fixing device comprising:
a fixing member to be used in fixing an image on a recording medium;
a rotatable member pressed against the fixing member while being allowed to rotate, the rotatable member cooperating with the fixing member in such a manner as to form a pressurization part where the recording medium is to be pressurized;
a rotating component configured to rotate the rotatable member by inputting a driving force to a position apart from an axis of the rotatable member; and
an urging component configured to urge at least one end of the rotatable member in such a manner as to move the one end in an approaching direction or a retracting direction relative to the fixing member.

2. The fixing device according to claim 1,
wherein the urging component includes a cam member.

3. The fixing device according to claim 2,
wherein the cam member includes a first cam member and a second cam member, the first cam member being provided at the one end, the second cam member being provided at an other end of the rotatable member, the other end being located opposite the one end, and
wherein the urging component is capable of causing at least one of the first cam member and the second cam member to rotate.

4. The fixing device according to claim 3,
wherein the first cam member and the second cam member each include a different-outline part where an outline of the cam member that is defined about a rotation center of the cam member is different from an outline of the other cam member.

5. The fixing device according to claim 4,
wherein the first cam member and the second cam member each include a conforming-outline part where the outline of the cam member that is defined about the rotation center conforms to the outline of the other cam member.

6. The fixing device according to claim 3,
wherein the first cam member and the second cam member are out of phase with each other.

7. The fixing device according to claim 1,
wherein the urging component includes a spring member provided at the one end of the rotatable member.

8. The fixing device according to claim 1,
wherein the urging component is configured to urge the rotatable member with reference to a current value of a drive source configured to generate the driving force to be inputted by the rotating component.

9. The fixing device according to claim 1,
wherein the urging component is configured to urge the rotatable member with reference to information representing a relationship between the driving force to be inputted by the rotating component and a degree of the urging.

10. The fixing device according to claim 1, further comprising:
an annular member that is to be rotated and is provided around the fixing member and the rotatable member,
wherein the annular member is rotated with a driving force generated by the rotatable member.

11. An image forming apparatus comprising the fixing device according to claim 1.

12. A fixing device comprising:
fixing means for fixing an image on a recording medium;
a rotatable member pressed against the fixing means while being allowed to rotate, the rotatable member cooperating with the fixing means in such a manner as to form a pressurization part where the recording medium is to be pressurized;
rotating means for rotating the rotatable member by inputting a driving force to a position apart from an axis of the rotatable member; and
urging means for urging at least one end of the rotatable member in such a manner as to move the one end in an approaching direction or a retracting direction relative to the fixing means.
